(19) United States
(12) Patent Application Publication
(10) Pub. No.: US 2021/0291237 A1
(43) Pub. Date: Sep. 23, 2021

(54) CYCLONIC VALVE AND METHOD FOR CLEANING PUMPS

(71) Applicant: VERNE TECHNOLOGY S.R.L., Milano (IT)

(72) Inventors: Carlo PERILLO, Lecco (IT); Lodovico FIOCCHI, Sarandi Grande (UY)

(21) Appl. No.: 16/319,526

(22) PCT Filed: Aug. 1, 2017
(86) PCT No.: PCT/IB2017/054706

§ 371 Date: Jan. 22, 2019

(30) Foreign Application Priority Data
Aug. 2, 2016 (IT) 102016000081332

(51) Int. Cl. B08B 9/032; B05B 1/34; B05B 1/14

(52) U.S. Cl. CPC B08B 9/0323; B05B 1/14; B05B 1/3405

(57) ABSTRACT

A cyclonic valve for cleaning pumps for transferring powders of any type in high density, including an inlet duct for introducing a flow of cleaning fluid, a flow dividing element adapted for dividing the flow in inlet into a plurality of flows, and a flow orienter having means for deviating and orienting in space the plurality of flows so as to give each of the flows a tangential motion component with respect to the direction of the flows, and then conveying the flows into one or more ducts towards the device to be cleaned, so as to generate a single cleaning flow in outlet having helical motion.

### TECHNICAL FIELD

The present disclosure concerns a cyclonic valve for cleaning ducts, particularly effective in particular for cleaning ducts of pumps for transferring high-density powders, for example used in painting plants or in other fields in which it is necessary to move particulate matter in powder state.

The cyclonic valve according to the present disclosure is designed to be used in cleaning pumps of high-density powder transfer systems, and therefore the present disclosure provides a pump for transporting powders of any type that comprises the cyclonic valve according to the present disclosure.

### BACKGROUND

In the field of powder transportation through conventional venturi pumps or high-density plants, for example but not only in industrial painting plants, special dedicated pumps make it possible not only to supply the powder to the paint guns, but also to recover and recirculate the so-called “overspray” powders from the painting chamber.

Currently, in the state of the art there are known high-density powder transfer pumps that use two tanks for processing powder, which operate in a continuous cycle in a two-stroke cycle: while the first tank loads with powder, the second tank is in the expulsion step. Subsequently, the operations in the two tanks reverse, and while the first tank discharges powder the second loads.

The loading/unloading operations in the two tanks therefore reverse in a continuous cycle according to a time predetermined by the manufacturer of the pump.

When speaking of high-density powder transportation pumps, reference is made to pumps adapted for transporting dry powders, reversing the current gas-powder percentages conventionally required in venturi pumps, using minimal amounts of gas, a large amount of dense phase powder is transported.

Given the need to process a high flow rate of powders, and therefore given the need to fill the tanks of the pump with a large amount of powder, the known solutions in which the pump provides for a two-stroke cycle that involves two tanks results in excessive loading and expulsion times of the powder, which translates into pulsed, discontinuous dispensing.

The time necessary to discharge the powder from a (loading) tank is the same that is necessary to load the powder into the other (discharging) tank.

Although the cycle is continuous, the powder becomes compacted in the transportation tube and the fact that large amounts of powder is sent, pushed by the pressurized air, causes a discontinuous feeding in which two volumes of powder expelled by the pump in two successive steps of the cycle are separated by the presence of air, actually creating pulsed dispensing.

Another drawback that affects known high-density powder transfer pumps of the state of the art is represented by the cleaning system of the pump itself.

Indeed, in the field there is a need to have deep and complete cleaning of the pump at the time of a change of powder, i.e., for example, in the case in which it is necessary to change the powder to move on to painting with a different color in quick time.

When a change of powder is carried out it is necessary for the pump to be cleaned so as to eliminate any possible residue of the powder used up to that moment.

The pumps known in the state of the art provide for two possible cleaning methods.

According to a first method, pressurized air is introduced into the tanks of the pump from the outside with radial direction, by means of a dedicated circuit. In this way, the air passes through the side walls of the pumping tubes inserted in the tanks, however this system does not ensure that the flow of cleaning air is effective since the crossing of the porous wall of the pumping tubes involves considerable load losses, which substantially reduce the pressure of the flow of cleaning air introduced to about 6 bars, thus losing efficiency particularly in the subsequent cleaning step of the ducts of the pump.

A second method, on the other hand, consists of supplying the pump with a flow of cleaning air having pressure of about 6 bars but with flow introduced from above with mainly axial direction in the tanks of the pump, with the risk that the flow rate of air only tangentially licking the inner walls of the tanks, and in particular of the pumping tubes consisting of porous material, which results in very limited cleaning efficiency.

Another drawback suffered by this second cleaning method known in the state of the art concerns the fact that the flow of cleaning air, directed mainly axially, undergoes a considerable load loss by crossing the tanks of the pump itself. The air, introduced at a pressure of about 6 bars upstream of the storage chambers of the powder of the pump, finally also in this case reaches the ducts of the pump assembly and of the valves close to the powder introduction and expulsion areas with reduced pressure, and thus speed. This considerably reduces the cleaning efficiency of the air flow.

Moreover, the fittings between the tanks of the pump and the cleaning air introduction duct are made of metallic material for sealing reasons, just as the non-return valve provided here is also made of metallic material.

Such metallic materials are therefore in continuous contact with the powder, and this also constitutes a drawback.

### BRIEF SUMMARY

The purpose of the present disclosure is therefore that of providing a cyclonic valve, i.e. a cleaning device, suitable for being associated with pumps for transferring high-density powders and powders of any type, that allows the drawbacks suffered by known solutions of the state of the art to be overcome, as well as a pump for transferring high-density powders and powders of any type that comprises such a cyclonic valve.

The disclosure avoids the aforementioned drawbacks by providing a cyclonic valve, i.e. a cleaning device, comprising at least one inlet duct for introducing cleaning fluid/gas, at least one flow dividing element adapted for dividing the flow in inlet into a plurality of flows, and at least one flow orienter configured to deviate and orient in space said plurality of flows so as to give each of said flows a tangential motion component with respect to the substantially rectilinear motion of said flows and joining said flows in a single cleaning flow, so as to generate a cleaning flow having helical motion that is conveyed to the pump to be cleaned.

The disclosure makes a cyclonic valve particularly for a pump for transferring powders of any type in high density, configured to be installed directly on the pump itself, so that said flow having helical motion is directed directly into the tank, or tanks, of the pump itself.

### BRIEF DESCRIPTION OF THE DRAWINGS

The characteristics and advantages of the cyclonic valve according to the present disclosure will become clearer from the following detailed description, given as an example and not for limiting purposes, referring to the attached schematic drawings, in which:

FIG. 1 is an exploded view of a pump for high-density powders comprising the cleaning cyclonic valve object of the present disclosure;

FIG. 1A is a schematic view of the pump for high-density powders of FIG. 1 in which the path of the cleaning flow inside the cyclonic valve and of the chambers from the pump is outlined;

FIGS. 2A and 2B show a view, from above and from below respectively, of the flow orienter element of the valve according to the present disclosure;

FIG. 3 is a view from above of the flow deviator element according to the present disclosure;

FIG. 4 shows the section according to the plane A-A indicated in FIG. 3;

FIG. 5 is a front view of the flow dividing elements of the cyclonic valve according to the present disclosure;

FIGS. 5A and 5B are perspective views of the flow dividing elements of FIG. 5;

FIG. 6 shows the section according to the plane A-A indicated in FIG. 5;

FIG. 7 shows a detail, in a view from above, of the flow orienter element of the valve according to the present disclosure;

FIG. 8 shows the section according to the plane C-C indicated in FIG. 7;

FIG. 9 shows a view from below of the detail of the flow deviator element of FIG. 7;

FIG. 10 shows an exploded view of the cyclonic valve according to the present disclosure in accordance with a second embodiment of the disclosure, where it is associated with a powder transportation pump having a single pumping chamber;

FIG. 11 shows a view from above of the flow dividing element of the cyclonic valve according to the present disclosure in accordance with the embodiment of FIG. 10;

FIG. 12 shows a perspective view of the flow orienter of the cyclonic valve according to the present disclosure in accordance with the second embodiment of FIG. 10.

### DETAILED DESCRIPTION

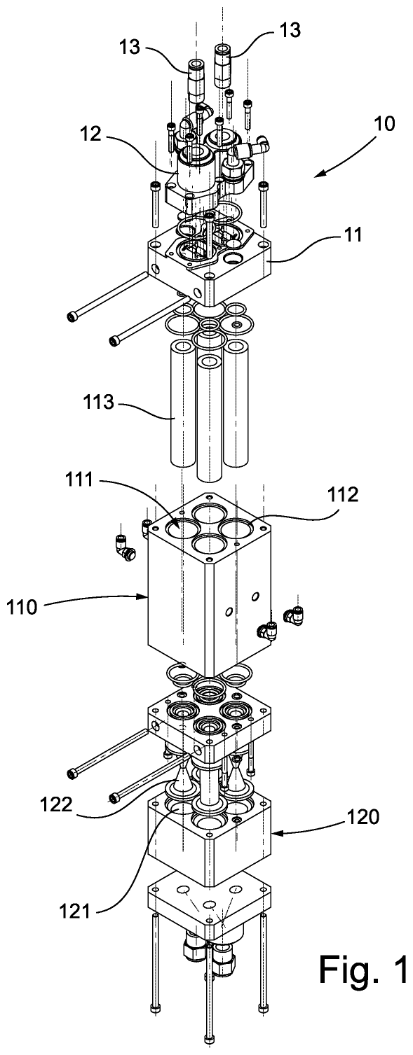

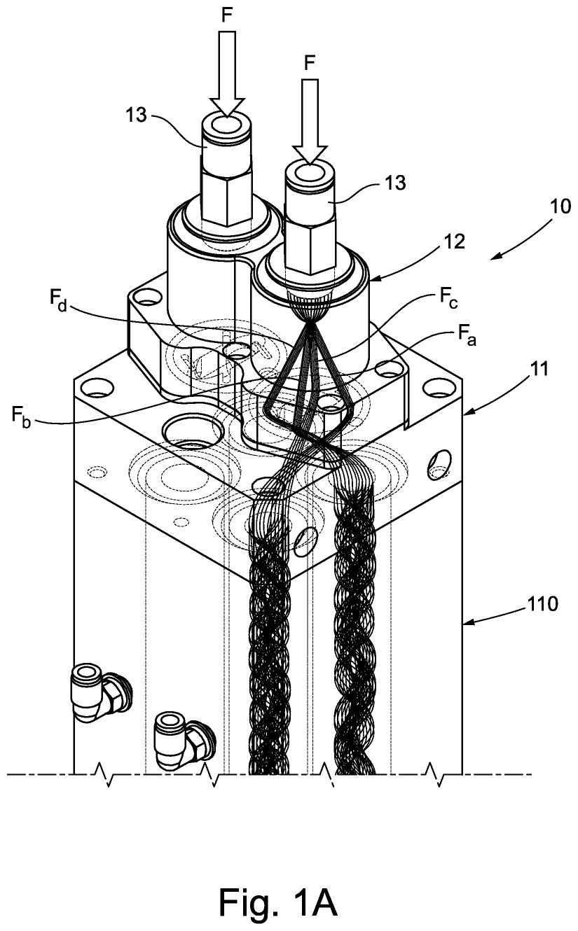

FIG. 1 shows a pump for high-density powder transportation 100 object of a separate patent application to the same Applicant.

It preferably comprises at least one pump body 110 and at least one valve assembly 120.

Said at least one pump body 110 in turn comprises a plurality of pumping chambers 111, and said valve assembly 120 comprises a plurality of seats 121 for as many valves 122, preferably pinch valves, and reference will be made thereto hereinafter with the expression “pinch valves”.

Said pump body 110 preferably has a box-like structure, preferably parallelepiped-shaped, and is configured to house a plurality of pumping chambers 111 inside it.

Each pumping chamber preferably comprises a cylindrical hole 112, extending mainly longitudinally, in which a pumping tube 113, also preferably cylindrical in shape and made with porous materials, is inserted.

Said pumping tubes 113, which can preferably be identical to one another, have a wall made of porous material suitable for allowing air to pass and for preventing the powder from passing, so that the air can pass through the wall of the pumping tube 113 but the powder is blocked by such a wall.

Possible porous materials that can be used to make the pumping tubes 113 are for example sintered plastics with variable porosity and pores of average size of about 15 microns, or other polymers having analogous characteristics of mechanical filtration of powders.

Said pumping tubes 113 are inserted with clearance in said cylindrical holes 112 of said pump body 110, so that said pumping chambers 111 further comprise an annular port arranged between the outer wall of the tube 113 and the inner wall of the cylindrical hole 112.

A pneumatic chamber is thus made in which it is possible to create, by means of a gas, preferably air, a positive or negative pressure with respect to the pressure that exists inside the pumping tube 113.

In this way, when, by means of the pneumatic circuit with which the pump 100 is equipped, a negative pressure, i.e. lower than the pressure that exists inside the pumping tube 113, is generated in said pneumatic chamber the powder is drawn, through the corresponding valve 122, in the pumping tube 113, when a positive pressure greater than the pressure that exists inside the pumping tube 113 is generated in said pneumatic chamber, the powder present in the pumping tube 113 is expelled, again passing through a corresponding valve 122.

The pneumatic circuit 150 for this purpose comprises at least one fitting 151 for each pumping chamber 111 for the pneumatic connection of each of said pneumatic chambers of said pumping chambers 111 to said pneumatic circuit 150.

In the same way, according to what is known in the state of the art, the pneumatic circuit 150 drives the opening and closing of the pinch valves 122, through a circuit branch 151 dedicated thereto.

Said pneumatic circuit 150 is driven by a central control unit, not shown in the figures, which coordinates the action of the valves and of the pumping chambers. Such a control unit is preferably programmable by the user according to different parameters, so as to be able to adjust the flow rate of the pump itself.

Without going into the constructive and operating details of the high-density powder transportation pump 100 referred to here that as stated is the disclosed in a separate patent application to the same Applicant, attention should be focused here on the problems concerning the cleaning of the pump, and in particular, but not only, the cleaning of the pumping tubes 113 which, as stated, comprise porous walls which are crossed by the working fluid but must hold the powders.

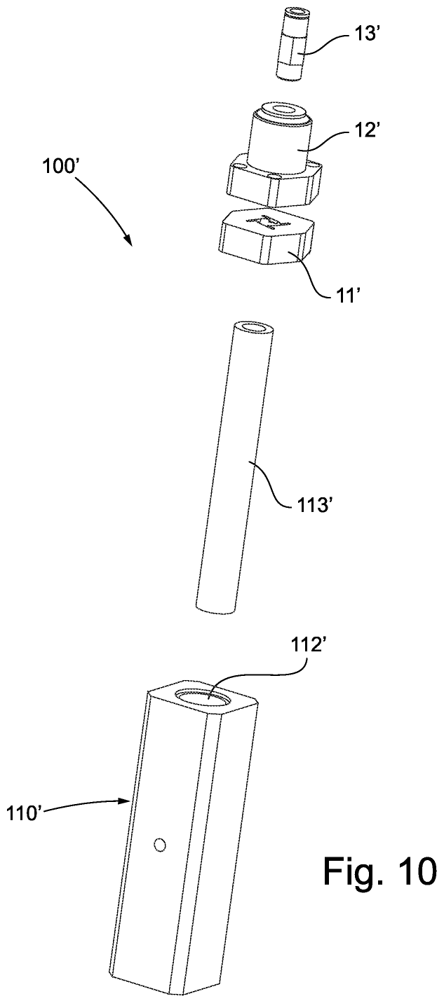

The same problems are suffered by a single-chamber pump 100′ shown as an example in FIG. 10, which comprises, inserted in the single cylindrical hole 112′ of the pump body 110′, a single pumping tube 113′.

The powders can over time clog up the pores of the pumping tubes 113, 113′ and all of the transportation tubes up to the powder outlet ducts arranged at the end of the pump, and cleaning systems must be suitably provided.

Currently, as stated in the introductory part of the present application, it is known in the state of the art to have systems having the radial inlet of a flow of cleaning air passing through the side walls of said pumping tubes 113, 113′, and systems having the axial inlet of a flow of cleaning air axially crossing said pumping tubes.

According to the present disclosure, and with particular reference to the attached figures where the cleaning cyclonic valve 10, 10′ according to the present disclosure is illustrated associated with a high-density powder transportation pump 100, 100′, said valve 10, 10′ comprises a flow dividing element 12, 12′ adapted for receiving a flow of cleaning air F from at least one inlet duct 13, 13′ for introducing a cleaning fluid F into said valve 10, 10′ and adapted for dividing said flow in inlet F into a plurality of flows Fa, Fb, Fc, Fd preferably having an angled direction with respect to the direction of said inlet flow F, and a flow orienter 11, 11′ comprising means for deviating and orienting in space said plurality of flows Fa, Fb, Fc, Fd at the same time giving each of said flows an angular component, so as to direct each of said flows Fa, Fb, Fc, Fd in the desired direction, at the same time giving the resulting flow a helical motion.

With particular reference to the figures, the cleaning valve 10, 10′ according to the present disclosure, said flow dividing element 12, 12′ comprises a nozzle 14, 14′ in turn comprising a substantially cylindrical portion 12a configured to receive a flow of cleaning air F in inlet, and a conical end portion that, in the cross section of FIG. 6, has a profile having walls 12b, 12′b inclined with respect to the axis of said first cylindrical portion 12a, 12′a, a plurality of outlet holes 12c, 12′c being formed on said inclined walls 12b, 12′b of said conical end portion so that the axial flow in inlet F is divided into a plurality of flows Fa, Fb, Fc, Fd oriented in space as a function of the angle that said inclined walls 12b, 12′b have with respect to the direction defined by the axis of the cylindrical portion 12a, 12′a of said nozzle 14, 14′.

In the embodiment illustrated here with reference to the attached figures, the flows oriented in space Fa, Fb, Fc, Fd are illustrated as being four for each flow divider 12, 12′, however alternative configurations of the cyclonic valve according to the present disclosure can comprise flow dividers adapted for dividing the flow in inlet into any number of flows, even more than four. Thus it is equally possible for there to be flow dividers adapted for dividing the flow in inlet into two, three, four, six, eight flows, or even more, without the present disclosure needing to be deemed in any way limited to a specific number of oriented flows.

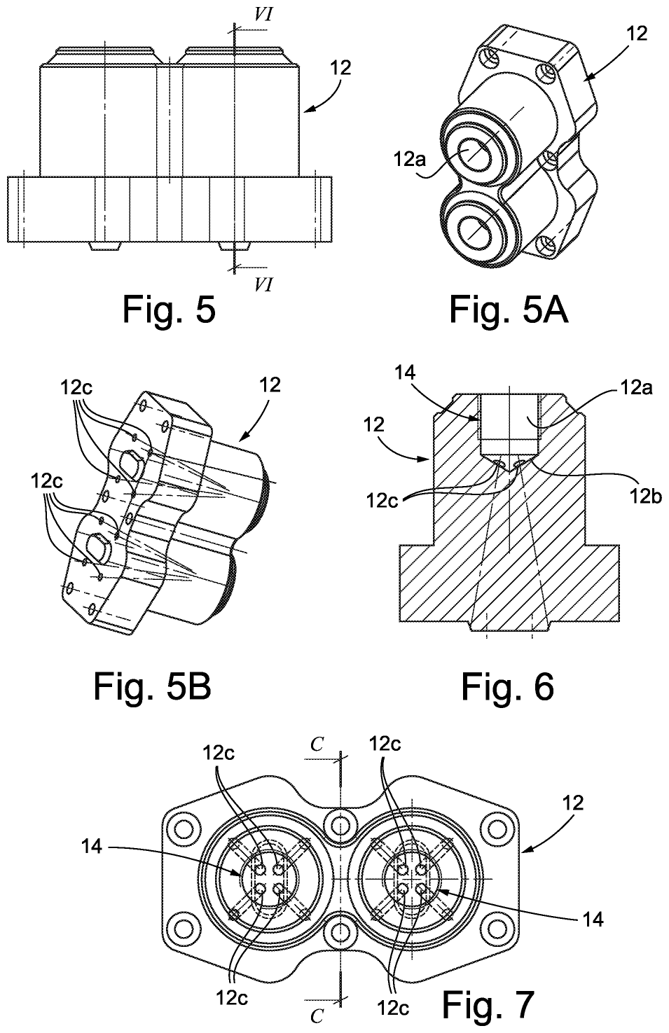

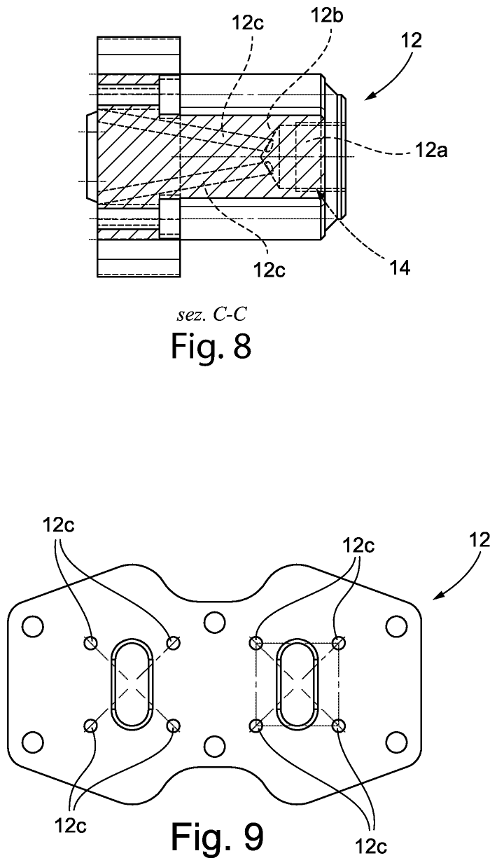

In the preferred embodiment of the cyclonic valve 10 according to the present disclosure shown in FIGS. 1 to 9, the valve 10 is intended to be associated with a powder transportation pump 100 having four chambers, and therefore the embodiment shown in FIGS. 5A and 5B provides for a pair of adjacent dividing elements 12.

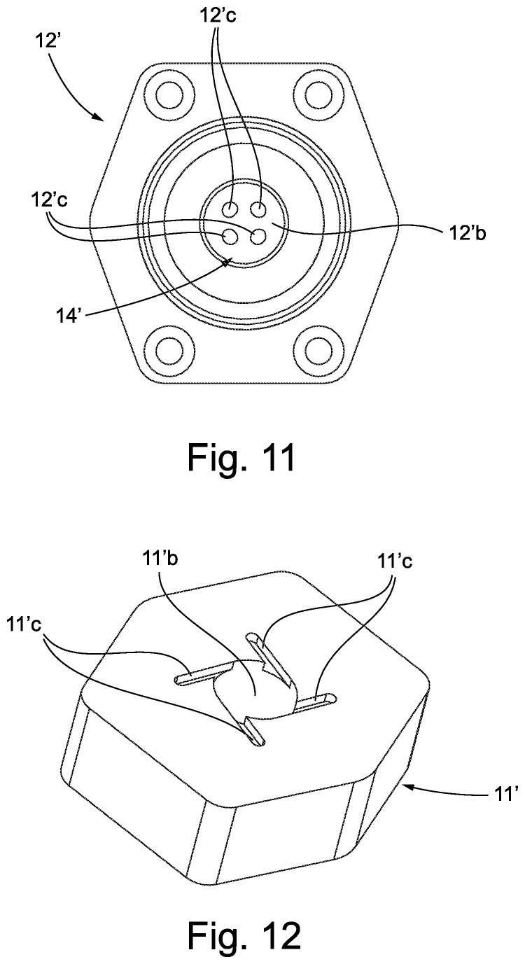

In the second embodiment shown in FIGS. 10 to 12, the valve is intended to be associated with a pump 100′ having a single chamber 112′, and therefore the valve provides for a single dividing element 12′, shown in particular in FIG. 12.

Going back to the first embodiment of the valve 10 according to the present disclosure configured to be associated with a pump having four chambers, each dividing element 12 is configured as described above, and is therefore adapted for dividing a flow F of fluid in inlet into a plurality of oriented flows Fa, Fb, Fc, Fd.

Each dividing element 12 divides the axial flow in inlet F into a plurality of flows Fa, Fb, Fc, Fd and orients such flows towards a pair of pumping chambers 112, in which said pumping tubes 113 are inserted.

In the embodiment shown in FIGS. 10 to 12, on the other hand, the dividing element 12′ divides the axial flow in inlet always in four oriented flows, however the oriented flows are then directed by the flow orienter 11′ towards the single pumping chamber 112′ in which a pumping tube 113′ is inserted.

Each dividing element 12, 12′ therefore preferably comprises a nozzle 14, 14′ in turn comprising four outlet holes 12c, 12′c of reduced diameter so as to give a high speed to the flows in outlet, so that four flows come out from each dividing element 12, 12′ that are oriented as a function of the inclination of the walls 12b, 12′b of said nozzle 14, 14′ on which said holes 12c, 12′c are formed.

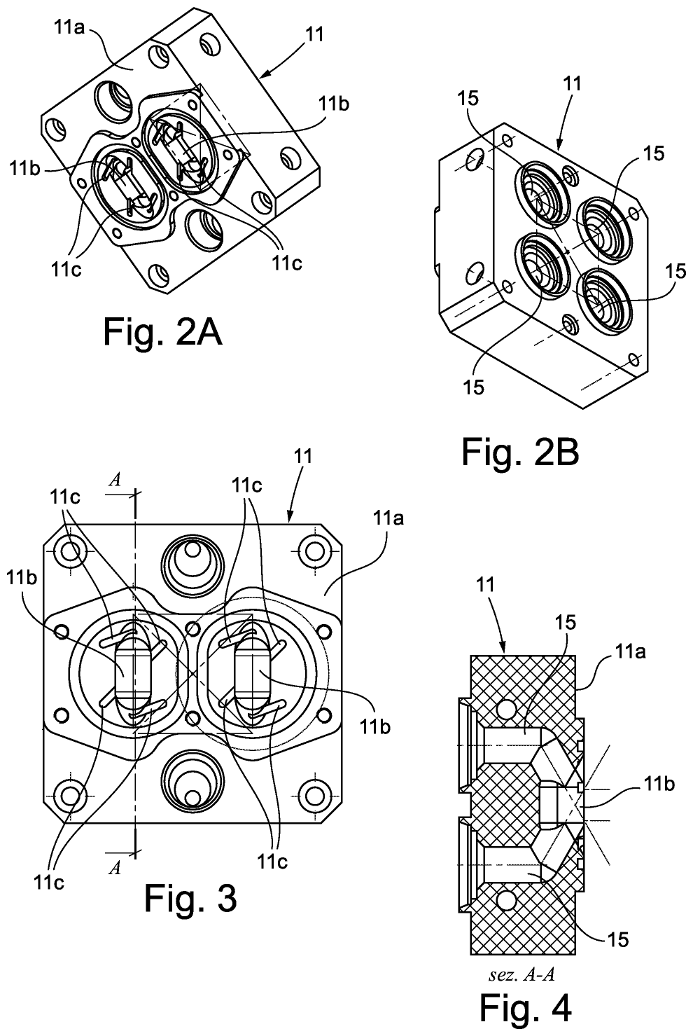

With particular reference to FIGS. 2A, 2B, 3, 10 and 12, said flow orienter 11, 11′ preferably is substantially box-shaped overall comprising an upper surface 11a, 11′a, intended to be associated with the lower portion of at least one of said dividing elements 12, 12′, and comprises means for deviating and orienting in space said plurality of flows Fa, Fb, Fc, Fd in outlet from said flow dividing element 12, 12′. Preferably, said means for deviating and orienting the flows comprise, on the upper surface 11a, 11′a of said flow orienter 11, 11′, a plurality of guiding grooves 11c, 11′ c, each guiding groove 11c being formed in a position corresponding to the position of the outlet holes 12c, 12′c of the dividing element 12, 12′, when said dividing element 12, 12′ and said flow orienter 11, 11′ are assembled.

Said guiding grooves 11c, 11′c are arranged on said upper surface 11a, 11′a of said flow orienter 11, 11′ according to tangential directions to the outer circumference of an axial through hole 11b, 11b′ formed in said flow orienter 11, 11′, also part of said means for deviating and orienting the flows in outlet from the divider 12, 12′.

More specifically, with reference to the perspective view of FIG. 10, said flow orienter comprises a substantially central through hole 11′b having at least one mouth portion having circular section on said upper surface 11a, 11′a of said flow orienter 11, 11′ and from which a plurality of, preferably four, guiding grooves 11′c extend along tangential directions, said grooves 11′c extending from diametrically opposite points of the outer circumference of said through hole 11′b, so that the flows Fa, Fb, Fc, Fd in outlet from said outlet holes 12c, 12′c of said nozzle 14, 14′ of said dividing element 14, 14′ each meet a corresponding guiding groove 11c, 11′c that conveys the flow, changing the motion thereof.

The shape of the guiding grooves 11c, 11′c gives each of the oriented flows that have, in outlet from the nozzle 14, 14′, a substantially axial motion component, a tangential component that changes the substantially rectilinear motion into a helical motion, so that the flow in outlet from said flow orienter 11, 11′ through said through hole 11b, 11′b is finally a flow having helical motion.

In the case of the first embodiment of the cyclonic valve 10 according to the present disclosure in which it is configured to be associated with a pump 100 having four pumping chambers, FIG. 4 shows how said central through hole 11b splits inside the body of the flow orienter 11 into two connection branches 15 that join said central hole 11b to two of the four pumping chambers 112 of the pump, thus conveying the flow with helical motion in said pumping tube 113.

The helical motion of the cleaning flow, in general comprising air or gas, ensures deep and complete cleaning of all of the internal elements of the pump 100, 100′ that are engaged by the flow of powder.

In particular, the cleaning flow is capable, thanks to its particular helical motion, of licking the porous walls of said pumping tube 113, 113′ with a sufficient speed to ensure an effective cleaning effect, so as to effectively and simply overcome the drawbacks left unresolved by known cleaning systems.

Advantageously, given that as stated the cleaning of the pump by means of the cyclonic valve 10, 10′ takes place occasionally, said cyclonic valve will comprise, upstream of said inlet duct 13, 13′, means for intercepting the cleaning fluid driven manually or in an automated manner by means of the control system of the pump with which said cyclonic valve is associated.

According to a preferred embodiment of the present disclosure, the cyclonic valve 10, 10′ in object is made entirely of plastic material, and allows the introduction of a uni-directional intermittent air flow with a pressure of about 6 bars.

The helical flow ensures the cleaning of the entire pump, including the transportation tubes up to their respective ends.

From the description given up to here the characteristics of the cyclonic valve 10, 10′ is particularly, but not exclusively, suitable for being associated with pumps for transferring high-density powders 100, 100′ are clear, just as the relative advantages are also clear.

Moreover, it should be understood that the cyclonic valve 10, 10′ thus conceived can undergo numerous modifications and variants, all of which are covered by the disclosure.

Moreover, all of the details can be replaced by technically equivalent elements.

The materials used, as well as the sizes, can be whatever according to the technical requirements.

1) Cyclonic valve for cleaning pumps for transferring high density powders of any type, comprising:
an inlet duct for introducing a flow of cleaning fluid,
a flow dividing element adapted for dividing the flow in inlet into a plurality of flows, and
a flow orienter comprising means for deviating and orienting in space said plurality of flows so as to give each of said flows a tangential motion component with respect to the direction of said flows, and then convey said flows into one or more ducts towards the device to be cleaned, so as to generate a single cleaning flow in outlet having helical motion.

2) Cyclonic valve according to claim 1, wherein said flow dividing element comprises at least one nozzle which in turn comprises at least one first cylindrical portion adapted for receiving a flow of cleaning air entering into said nozzle and coming from said inlet duct, and a conical end portion comprising a plurality of outlet holes adapted for dividing the flow in inlet into a plurality of outlet flows.

3) Cyclonic valve according to claim 1, wherein said means for deviating and spatially orienting said plurality of flows exiting from said flow dividing element comprise a through hole having at least one mouth portion having a circular section, and a plurality of guiding grooves which extend along tangential directions from said inlet portion having a circular section.

4) Cyclonic valve according to claim 1, wherein said guiding grooves extend from diametrically opposite points of said inlet portion having a circular section of said through hole.

5) Cyclonic valve according to one or more of claim 1, wherein there are four of said outlet holes adapted for dividing the flow in inlet, so as to divide the inlet flow into four outlet flows exiting from said nozzle of said flow divider.

6) Cyclonic valve according to one or more of claim 1, wherein there are four of said guiding grooves for said outlet flows exiting from said nozzle of said flow divider.

7) Cyclonic valve according to one or more of claim 1, wherein it is made of plastic material.

8) Pump for high density powders, wherein it comprises a cyclonic valve according to one or more of claim 1.

9) Pump for high density powders according to claim 1, wherein it comprises four pumping chambers and in that said cleaning valve comprises a pair of flow dividing elements and a pair of flow orienters.

10) Method for cleaning pumps for high density powders comprising the steps of:
conveying a cleaning flow of air or gas towards an inlet duct;
dividing said cleaning flow into a plurality of flows;
giving said plurality of flows a tangential motion component and joining them back together, conveying them through one or more ducts towards the pump to be cleaned, thus giving the resulting flow a helical motion.

11) Method for cleaning pumps for high density powders according to claim 11, wherein said resulting flow having helical motion is conveyed in the pumping chamber of said pump for high density powders in which a pumping tube is housed.
